(19) United States
(12) Patent Application Publication
(10) Pub. No.: US 2008/0102819 A1
(43) Pub. Date: May 1, 2008

(54) SYSTEM AND METHOD FOR VERIFYING CONTACT DATA

(76) Inventors: Henrik Bengtsson, Lund (SE); David Burstrom, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/554,058

(22) Filed: Oct. 30, 2006

(51) Int. Cl. H04Q 7/20

(52) U.S. Cl. 455/425

(57) ABSTRACT

A method of verifying contact data that has been entered into an electronic device by a user includes transmitting alphanumeric characters of the contact data to a server. In turn, verification data associated with the contact data is received from the server and the verification data is displayed.

### TECHNICAL FIELD OF THE INVENTION

The present invention relates generally to an electronic device such as a mobile telephone and, more particularly, to a system and method for verifying contact data as the contact data is entered by a user.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

When dialing a telephone number, the user of a telephone may not know if the digits that the user has entered are correct for the intended person to be called. In response to the depression of alphanumeric keys to enter a telephone number, some telephones display the corresponding telephone number digits. But the user may not notice if an unintended key is pressed. For instance, if the user were to accidentally depress the eight key instead of the five key, the user may not notice. Nor may the user notice if a key is unintentionally depressed twice. In other situations, the user may not know if the telephone number that the user has in his or her possession is the correct number for the person with whom the user wishes to speak.

### SUMMARY

To improve the accuracy of telephone dialing and/or sending a message, there is a need in the art for a system and method for verifying contact data as the contact data is entered into an electronic device. In one embodiment, the contact data is verified automatically (e.g., without user interaction) and with minimal or no delay to the dialing or messaging operation.

According to one aspect of the invention, a method of verifying contact data that has been entered into an electronic device by a user includes transmitting alphanumeric characters of the contact data to a server; receiving verification data associated with the contact data from the server; and displaying the verification data.

According to one embodiment of the method, each character is transmitted individually as the characters are entered by the user.

According to one embodiment of the method, the server conducts a search for the verification data by at least one of searching a database, invoking another server to search a database or invoking a look-up service.

According to one embodiment of the method, if no verification data for the contact data is identified during the search, the server transmits verification data that results in the display of an indication to the user that no relevant data to verify the contact data was identified.

According to one embodiment of the method, the verification data is a name of a person or an entity associated with the contact data.

According to one embodiment of the method, the electronic device is a mobile telephone.

According to one embodiment of the method, the contact data is a telephone number and the method is carried out in connection with at least one of entry of the telephone number for establishing a call or entry of the telephone number to populate a contact list entry.

According to one embodiment of the method, the contact data is one of an electronic mail address, a text message address or an instant message address and the method is carried out in connection with at least one of entry of the contact data for addressing a corresponding message or entry of the contact data to populate a contact list entry.

According to another aspect of the invention, a method of verifying contact data that has been entered into an electronic device by a user includes receiving alphanumeric characters of the contact data with a server; conducting a search for the verification data associated with the contact data; and transmitting the verification data to the electronic device.

According to one embodiment of the method, the alphanumeric characters are received individually after each character has been respectively entered into the electronic device by the user.

According to one embodiment of the method, if no verification data for the contact data is identified during the search, the server transmits verification data that indicates that no relevant data to verify the contact data was identified.

According to one embodiment of the method, the verification data is a name of a person or an entity associated with the contact data.

According to one embodiment of the method, the electronic device is a mobile telephone.

According to one embodiment of the method, the contact data is a telephone number.

According to one embodiment of the method, the contact data is one of an electronic mail address, a text message address or an instant message address.

According to yet another aspect of the invention, a program stored on a machine readable medium to verify contact data that has been entered into an electronic device by a user includes executable logic to transmit alphanumeric characters of the contact data to a server; receive verification data associated with the contact data from the server; and display the verification data.

According to one embodiment of the program, each character is transmitted individually as the characters are entered by the user.

According to one embodiment of the program, the verification data is a name of a person or an entity associated with the contact data.

According to one embodiment of the program, the electronic device is a mobile telephone and the program is stored and executed by the mobile telephone.

According to one embodiment of the program, the contact data is a telephone number that is entered for at least one of establishing a call or populating a contact list entry.

According to one embodiment of the program, the contact data is one of an electronic mail address, a text message address or an instant message address.

According to still another aspect of the invention, a mobile radio terminal includes a radio circuit to establishing a call over a communications network; and a control circuit that is configured to verify contact data that has been entered into the mobile radio terminal by a user by transmitting alphanumeric characters of the contact data to a server; receiving verification data associated with the contact data from the server; and displaying the verification data.

According to one embodiment of the mobile radio terminal, each character is transmitted individually as the characters are entered by the user.

According to one embodiment of the mobile radio terminal, the verification data is a name of a person or an entity associated with the contact data.

According to one embodiment of the mobile radio terminal, the electronic device is a mobile telephone.

According to one embodiment of the mobile radio terminal, the contact data is a telephone number that is entered for at least one of establishing a call or populating a contact list entry.

According to one embodiment of the mobile radio terminal, the contact data is one of an electronic mail address, a text message address or an instant message address.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention;

FIG. 2 is a schematic block diagram of the mobile telephone of FIG. 1 in accordance with an embodiment of the present invention;

FIG. 3 is a schematic diagram of a communications system in which the mobile telephone of FIG. 1 may operate;

FIG. 4 is a flow chart representing an exemplary contact data verification function executed by the mobile telephone of FIG. 1; and

FIG. 5 is a flow chart representing an exemplary contact data verification support function executed by a server of the communication system of FIG. 3.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of appropriate electronic equipment, examples of which include a media player, a gaming device and a computer.

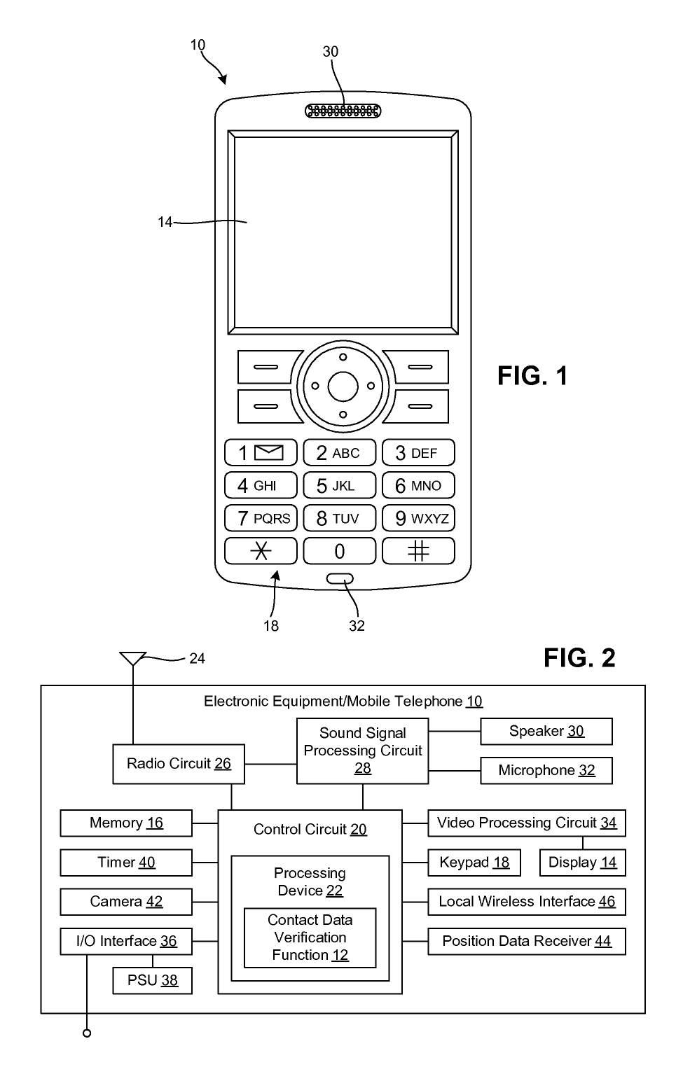

Referring initially to FIGS. 1 and 2, an electronic device 10 is shown. The electronic device 10 includes a contact data verification function 12 that is configured to assist a user of the electronic device confirm that the user has entered contact data corresponding to an intended party to be called or an intended message destination. Additional details and operation of the contact data verification function 12 will be described in greater detail below. The contact data verification function 12 may be embodied as executable code that is resident in and executed by the electronic device 10. In one embodiment, the contact data verification function 12 may be a program stored on a computer or machine readable medium. The contact data verification function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other type housings, such as a clamshell housing or a slide-type housing, may be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 16. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi, WiMax, etc. Another example includes a video enabled call that is established over a cellular or alternative network.

The mobile telephone 10 may be configured to transmit, receive and/or process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as memory 16, in order to carry out operation of the mobile telephone 10. The memory 16 may be, for example, one or more of a buffer, a flash memory, a hard drive, a removable media, a volatile memory, a non-volatile memory or other suitable device.

In addition, the processing device 22 may execute code that implements the contact data verification function 12. It will be apparent to a person having ordinary skill in the art of computer programming, and specifically in application programming for mobile telephones or other electronic devices, how to program a mobile telephone 10 to operate and carry out logical functions associated with the contact data verification function 12. Accordingly, details as to specific programming code have been left out for the sake of brevity. Also, while the contact data verification function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 18 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream received by the radio circuit 28 or obtained by any other suitable method.

The mobile telephone 10 further includes one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 may also include a timer 40 for carrying out timing functions. Such functions may include timing the durations of calls, generating the content of time and date stamps, etc. The mobile telephone 10 may include a camera 42 for taking digital pictures and/or movies. Image and/or video files corresponding to the pictures and/or movies may be stored in the memory 16. The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF adaptor (e.g., a Bluetooth adapter), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

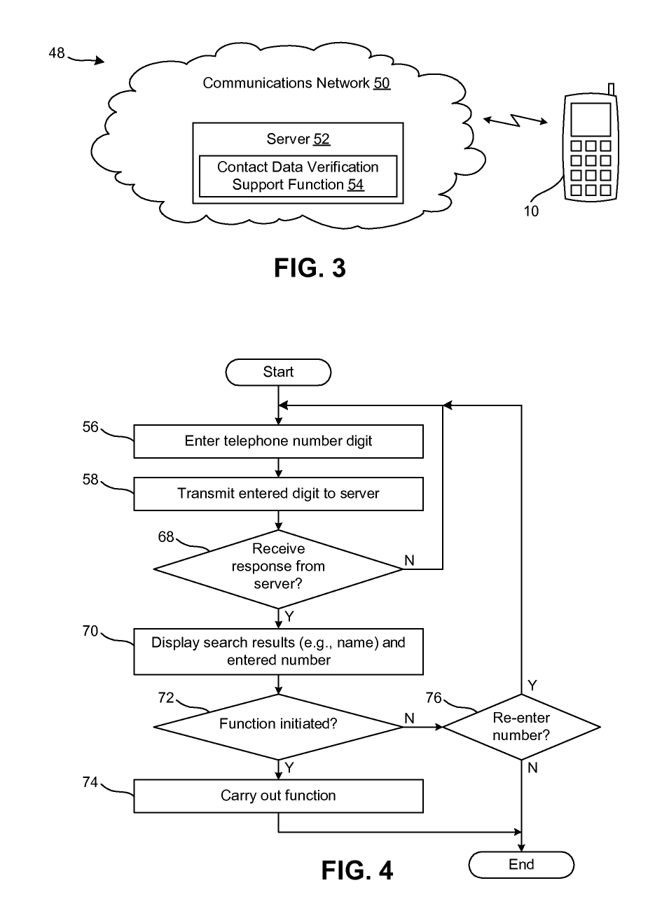

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software. In one embodiment, the server 52 may be configured to store and execute a contact data verification support function 54 that interacts with the contact data verification function 12 of the mobile telephone 10. Details of the contact data verification support function 54 will be described below in greater detail. In one embodiment, the contact data verification support function 54 may be a program stored on a computer or machine readable medium. The contact data verification support function 54 may be a stand-alone software application or may form a part of a software application that carries out additional tasks related to the functions of the server 54. In one embodiment, the functions of the contact data verification support function 54 may be distributed among multiple servers, including one or more servers located outside the domain of the communications network 50. For instance, search features of the contact data verification support function 54 may be hosted by an Internet server or a database server.

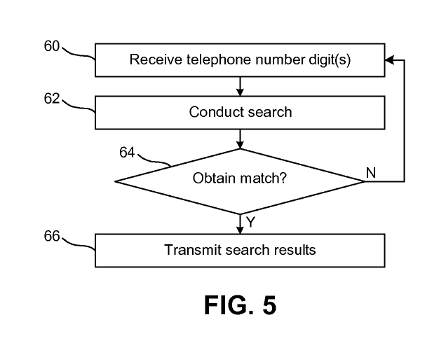

With additional reference to FIGS. 4 and 5, illustrated are logical operations to implement an exemplary method of verifying contact data. The exemplary method may be carried out by, for example, executing an embodiment of the contact data verification function 12 and executing an embodiment of the contact data verification support function 54. Thus, the flow chart of FIG. 4 may be thought of as depicting steps of a method carried out by the mobile telephone 10 and the flowchart of FIG. 5 may be thought of as depicting steps of a method carried out by the server 52. Although FIGS. 4 and 5 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The methods and systems for verifying contact data are described in the exemplary context of dialing a telephone number. It will be appreciated that the methods and systems may be applied to other scenarios. For instance, aspects of the methods and systems may be applied to populating a telephone number field of a contact list entry, sharing a telephone number with another device (e.g., generating an ad hoc electronic business card) and so forth. Also, aspects of the methods and systems may be applied to types of contact data other than a telephone number. For example, an electronic mail address, a text message address and/or an instant message address may be verified in a manner similar to that described below for verifying a telephone number. Therefore, while aspects of the methods and systems are described with respect to dialing a telephone number, the invention is not so limited.

The logical flow for the contact data verification function 12 may begin in block 56 where the user starts to dial a telephone number by entering a telephone number digit. For instance, the user may depress an alphanumeric key from the keypad 18 to enter the telephone number digit. Depending on the operational mode of the mobile telephone 10, the depression of an alphanumeric key may commence the dialing process conventionally associated with calling a telephone number.

For purposes of telephone number verification, the telephone number digit entered in block 56 may be transmitted in block 58 to the server 52. The entered digit may be transmitted without waiting for a complete telephone number to be entered. As will be described below in greater detail, the server 52 may collect telephone number digits that are individually transmitted in block 58 for verification.

Referring now to logical operations carried out by the server 52, the digits transmitted in block 58 may be received and collected by the server 52 in block 60 (FIG. 5). Thereafter, in block 62, the contact data verification support function 54 may be configured to conduct a search to identify verification data that is associated with the received telephone number digits. The verification data may be, for example, a name of a person or an entity (e.g., a company) that “owns” or is associated with the telephone number. The search carried out in block 62 may be based on the digits received. Therefore, if a partial telephone number has been entered by the user thus far in the method, the search may be made on the partial telephone number.

In one embodiment, one or more databases or services that associate telephone numbers with corresponding information may be searched to identify the person or entity that would be called if a call were placed to the telephone number received in block 60. The search may include searching a commercially available “reverse telephone directory,” a database maintained by a communications network service provider that operates the communications network 50, and/or any other suitable telephone number or contact information lookup service. Such services may include, for example, the “Yellow Pages” and/or the “White Pages” in the United States, “Hitta.se” in Sweden, and similar services. In one embodiment, the searched database and/or service may be confined to a database and/or service having a relationship to the entered telephone number. For example, if the entered number is for a particular geographical area, such as a region covered by an area code in the United States, a telephone directory database for the area code may be searched. As another example, if the telephone number is identified as a telephone number for a mobile telephone, a telephone directory database for mobile telephone numbers may be searched.

In one embodiment, a database may be generated to associate nicknames and/or more than one name with a telephone number. For instance, the owner of a telephone number may desire to keep his or her name confidential, but may populate the database with an owner selected nickname for use as the verification data that the contact data verification techniques described herein may access. As another example, there are situations where multiple persons may be contacted through a single telephone number, such as a family that shares a conventional landline telephone number. In that case, the database may store all of the persons reachable through the telephone number and each of those names may be identified in the search of block 62 or a group name (e.g., a family's last name) may be identified in the search of block 62.

Proceeding to block 64, the search may result in the identification of a name that is associated with the telephone number received in block 60. In other cases, the search may not result in the identification of a name that is associated with the telephone number received block 60. For example, if only a partial telephone number has been transmitted to the mobile telephone thus far, a match may not be obtained. Also, a match may not be obtained if no name is associated with the telephone number (e.g., if the telephone number is an “unlisted” telephone number or if none of the searched databases or services identify a match). If a negative determination is made in block 64, the logical flow may return to block 60 to await reception of another telephone digit. Also, the server 52 may be configured to recognize if the search of block 62 was carried out on a complete telephone number. For example, in the United States, a local telephone number may be identified by the entry of seven digits, where the first digit is a number other than one. Also, in the United States, a long-distance telephone number may be identified by the entry of the number one followed by ten additional digits. Other countries have predetermined formats for telephone numbers and, based on an expected digit value and/or number of digits, a determination may be made as to whether a user in a country other than the United States has entered the last digit of a telephone number. Also, international calls may be identified by entry of an international operator prefix (e.g., “011” in the United States) and/or a country code. Thus, a determination may be made as to whether the user has entered the last digit of an international telephone number. If the search was conducted on a full telephone and no match was obtained, the logical flow may proceed to block 66 and the search results may be a “null set.”

In block 66, the search results (e.g., the verification data or the null set) may be transmitted from the server 52 to the mobile telephone 10. For instance, if a name that is associated with the telephone number is identified during the search, the name may be transmitted to the mobile telephone 10 in block 66. If no name or other relevant search result is identified during a search, the server 52 may transmit an indication that no relevant data was identified.

Referring again to the logical operations carried out by the mobile telephone 10, the search result that was transmitted by the server 52 in block 66 may be received by the mobile telephone 10 in block 68. Thereafter, the mobile telephone 10 may display the search results in block 70. For instance, if a name was returned by the contact data verification support function 54, the name may be displayed on the display 14 along with the telephone number that was entered by the user. If no name or other relevant search result was identified during a search (e.g., the null set), only the telephone number that was entered by the user may be displayed. Alternatively, a message indicating that the mobile telephone 10 was unable to verify the entered telephone number may be displayed. If it is determined that the entered telephone number is an unlisted telephone number, this information may be communicated to the user, such as by displaying the phrase “unlisted number.”

The logical flow may proceed to block 72 where a determination is made as to whether the user takes action to carry out a function related to the entered telephone number. It is noted that action to initiate a function may be detected at any time in the process (e.g., before a response is received in block 68 and/or search results are displayed in block 70). Thus, state variables may indicate that certain blocks carried out by the mobile telephone 10 and/or the server 54 should be skipped in favor of advancing the logical flow in an order different than the illustrated order.

One exemplary function that may be initiated in block 72 is the calling of the entered telephone number. For instance, a positive determination may be made in block 72 if the user depresses a call send button that forms part of the keypad 18. If a positive determination is made in block 72, the logical flow may proceed to block 74 were the call is commenced in a conventional manner. Other functions may include saving a contact list entry, sending the entered telephone number to another device (e.g., transmitting an “ad hoc” business card to another mobile telephone), and so forth. Another function may include sending a message, such as a text message, instant message or an electronic mail message. For instance, the user may select a menu option to generate and/or send the message to an address associated with the entered telephone number.

A negative determination may be made in block 72 if the user takes action to delete the entered number, edit the entered number or otherwise terminate the call initiation process. If a negative determination is made in block 72 the logical flow may proceed to block 76, where the user may be offered a menu option to reenter or edit the entered telephone number. In block 76, a determination may be made as to whether the user has begun to enter a new telephone number or edit the previously entered telephone number. If a positive determination is made in block 76 the logical flow may return to block 56. If a negative determination is made in block 76, the logical flow of the illustrated embodiment may end.

As will be appreciated, it may be desirable to return search results from the server 52 to the mobile telephone 10 and to display the search results to the user as quickly as possible. Therefore, in the illustrated embodiment individual entered telephone number digits are transmitted to the server in block 58 as the digits are entered in block 56. In this manner, the server 52 receives entered digits during the data entry process without waiting for an entire telephone number to be entered. In turn, the contact data verification support function 54 may start a corresponding search on the partially received data, such as identifying which databases to search and/or which services to utilize. Also, the partially received data may be used to progressively narrow the number of potentially matching search results. In other embodiments, the contact data verification function 12 may be configured to transmit all of the entered telephone number digits to the server 52 at one time for processing by the contact data verification support function 54 (e.g., after entry of the last digit of a telephone number is detected).

It is contemplated, that a search results may be obtained by the server 52, returned to the mobile telephone 10 and displayed in less than one second. For instance, these operations may be carried out in the order of milliseconds so that there is minimal or no operational delay perceived by the user. In some cases, it may be possible to display the verification data in the time between user depression of the key for the last digit of the telephone number and user depression of the call send button.

Expediting contact data verification also may be enhanced by establishing an operative connection between the mobile telephone 10 and the server 52 upon startup of the mobile telephone 10. For instance, a session between the mobile telephone 10 and the server 52 to support contact data verification may be established. Also, the server 52 may establish operative connections with other servers that are used to assist in the search function of block 64, including database servers and servers that host appropriate services. Those other servers may form part of the communications network 50 or may be accessed through another network, such as the Internet.

As indicated, the contact data verification function 12 may be adapted for use in situations other than initiating a telephone call by user entry of telephone number digits. For instance, the contact data verification function 12 may be used during data entry to populate fields of a contact list entry. In one embodiment, when the user enters a telephone number into a contact list entry, the contact data verification function 12 may be used in conjunction with the contact data verification support function 54 to search for verification data (e.g., a name of a person or entity associated with the entered number). Returned search results may be displayed so that the user may verify that he or she has entered an intended telephone number. If the intended telephone number has been entered, the user may store the number as part of the contact list entry. If the verification process indicates that the user has entered a telephone number other than the intended telephone number, then the user may reenter or edit the entered telephone number.

Also, the contact data verification function 12 may be used to verify types of contact data other than telephone numbers. For instance, electronic mail addresses, text message addresses and/or instant message addresses may be verified by the same or similar techniques as described above for verifying that the user has entered an intended telephone number. In one embodiment, a database (or databases) of these other exemplary forms of contact data may store the contact data with associated verification data, such as owner names. When an electronic mail address, text message address and/or instant message address is entered by the user of the mobile telephone 10, the contact data verification function 12 in conjunction with the contact data verification support function 54 may carry out logical operations to display verification data to the user.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of verifying contact data that has been entered into an electronic device by a user, comprising:
transmitting alphanumeric characters of the contact data to a server;
receiving verification data associated with the contact data from the server; and
displaying the verification data.

2. The method of claim 1, wherein each character is transmitted individually as the characters are entered by the user.

3. The method of claim 1, wherein the server conducts a search for the verification data by at least one of searching a database, invoking another server to search a database or invoking a look-up service.

4. The method of claim 3, wherein if no verification data for the contact data is identified during the search, the server transmits verification data that results in the display of an indication to the user that no relevant data to verify the contact data was identified.

5. The method of claim 1, wherein the verification data is a name of a person or an entity associated with the contact data.

6. The method of claim 1, wherein the electronic device is a mobile telephone.

7. The method of claim 1, wherein the contact data is a telephone number and the method is carried out in connection with at least one of entry of the telephone number for establishing a call or entry of the telephone number to populate a contact list entry.

8. The method of claim 1, wherein the contact data is one of an electronic mail address, a text message address or an instant message address and the method is carried out in connection with at least one of entry of the contact data for addressing a corresponding message or entry of the contact data to populate a contact list entry.

9. A method of verifying contact data that has been entered into an electronic device by a user, comprising:
receiving alphanumeric characters of the contact data with a server;
conducting a search for the verification data associated with the contact data; and
transmitting the verification data to the electronic device.

10. The method of claim 9, wherein the alphanumeric characters are received individually after each character has been respectively entered into the electronic device by the user.

11. The method of claim 9, wherein if no verification data for the contact data is identified during the search, the server transmits verification data that indicates that no relevant data to verify the contact data was identified.

12. The method of claim 9, wherein the verification data is a name of a person or an entity associated with the contact data.

13. The method of claim 9, wherein the electronic device is a mobile telephone.

14. The method of claim 9, wherein the contact data is a telephone number.

15. The method of claim 9, wherein the contact data is one of an electronic mail address, a text message address or an instant message address.

16. A program stored on a machine readable medium to verify contact data that has been entered into an electronic device by a user, comprising executable logic to:
transmit alphanumeric characters of the contact data to a server;
receive verification data associated with the contact data from the server; and
display the verification data.

17. The program of claim 16, wherein each character is transmitted individually as the characters are entered by the user.

18. The program of claim 16, wherein the verification data is a name of a person or an entity associated with the contact data.

19. The program of claim 16, wherein the electronic device is a mobile telephone and the program is stored and executed by the mobile telephone.

20. The program of claim 16, wherein the contact data is a telephone number that is entered for at least one of establishing a call or populating a contact list entry.

21. The program of claim 16, wherein the contact data is one of an electronic mail address, a text message address or an instant message address.

22. A mobile radio terminal, comprising:
a radio circuit to establishing a call over a communications network; and
a control circuit that is configured to verify contact data that has been entered into the mobile radio terminal by a user by transmitting alphanumeric characters of the contact data to a server; receiving verification data associated with the contact data from the server; and displaying the verification data.

23. The mobile radio terminal of claim 22, wherein each character is transmitted individually as the characters are entered by the user.

24. The mobile radio terminal of claim 22, wherein the verification data is a name of a person or an entity associated with the contact data.

25. The mobile radio terminal of claim 22, wherein the electronic device is a mobile telephone.

26. The mobile radio terminal of claim 22, wherein the contact data is a telephone number that is entered for at least one of establishing a call or populating a contact list entry.

27. The mobile radio terminal of claim 22, wherein the contact data is one of an electronic mail address, a text message address or an instant message address.
